(19) United States
(12) Patent Application Publication
(10) Pub. No.: US 2026/0309555 A1
(43) Pub. Date: Oct. 8, 2026

(54) DIFFERENTIAL POWER COMPENSATION TYPE BATTERY ISOTHERMAL CALORIMETER AND DYNAMIC CHARACTERISTIC CORRECTION METHOD

(71) Applicant: CHINA JILIANG UNIVERSITY, Hangzhou City (CN)

(72) Inventors: Jinxin XU, Hangzhou City (CN); Kaigu ZHU, Hangzhou City (CN); Jiaying TANG, Hangzhou City (CN); Jiong DING, Hangzhou City (CN); Dongfang HU, Hangzhou City (CN); Taoran TANG, Hangzhou City (CN); Yunpeng ZHANG, Hangzhou City (CN); Jiali TANG, Hangzhou City (CN); Yang SHEN, Hangzhou City (CN); Xinchen MAO, Hangzhou City (CN); Dongwei LI, Hangzhou City (CN); Xu YAN, Hangzhou City (CN)

(21) Appl. No.: 19/303,375

(22) Filed: Aug. 19, 2025

(30) Foreign Application Priority Data
Apr. 8, 2025 (CN) 202510434387.X

(51) Int. Cl. G01K 19/00; G01K 17/04; H01M 10/0525; H01M 10/48; H02J 7/00

(52) U.S. Cl. CPC G01K 19/00; G01K 17/04; H01M 10/486; H02J 7/80; H01M 10/0525

(57) ABSTRACT

A differential power compensation type battery with isothermal calorimeter and dynamic characteristic correction method is disclosed. A constant temperature heat sink provides a stable temperature boundary, installs a battery to be tested and a reference battery in a constant temperature calorimetric chamber, and heats to a target temperature. During the charging and discharging process, the power of the reference-side heating sheet is used as the baseline power, feedback control is performed on the output power of the sample-side heating sheet, and the real-time output powers are collected and recorded. Based on piecewise polynomial fitting of curves, constraint conditions are added, thereby obtaining the fitted power value and power change rate value. The real-time heat generation power of the battery to be tested during charging and discharging may be obtained, and thus the heat generation of the battery may be calculated.

### CROSS-REFERENCE TO RELATED APPLICATIONS

This application claims priority to Chinese Patent Application No. 202510434387.X, filed on Apr. 8, 2025, the contents of which are hereby incorporated by reference.

### TECHNICAL FIELD

The present disclosure belongs to the field of lithium battery thermal characteristic detection, and specifically relates to a differential power compensation type battery isothermal calorimeter and a dynamic characteristic correction method.

### BACKGROUND

Currently, calorimeters used in lithium-ion battery heat generation research mainly include adiabatic acceleration rate calorimeters and isothermal calorimeters. The measurement principle of an adiabatic acceleration rate calorimeter is to maintain the dynamic equality of temperatures between the calorimetric chamber and the measured object, thereby keeping the measured object in an adiabatic state. When the measured object generates heat, the heat is only used to heat the object itself, so that the adiabatic temperature rise is obtained, and finally the heat generation power of the measured object is obtained through calculation of the adiabatic temperature rise rate. The measurement principle of an isothermal calorimeter is to keep the temperatures of the calorimetric chamber and the measured object constant, so that the measured object is in an isothermal state. When the measured object generates heat, the heating power is adjusted through real-time feedback to maintain the temperature of the measured object constant, so that the heat generation power of the measured object is obtained, and the heat absorption or release under this temperature condition is measured.

The adiabatic acceleration rate calorimeter may simulate the thermal characteristics of the battery during exothermic reactions when internal heat of the battery may not be dissipated in a timely manner. With its rich and diverse functions, it is widely used in the field of battery thermal management. However, it has the following shortcomings: firstly, it has no refrigeration function and may not quickly track the temperature during the battery cooling process, so it is difficult to measure endothermic effects; secondly, due to the existence of thermal hysteresis, the instrument may not enter a true adiabatic state, resulting in measurement errors; thirdly, it may not accurately measure the heat generation power of the battery at a certain fixed temperature point. Compared with the adiabatic acceleration rate calorimeter, the isothermal calorimeter has the following advantages: firstly, it may directly measure the heat absorption or release power of the battery; secondly, the measurement accuracy of the battery charging and discharging heat generation power is relatively high; thirdly, it may accurately measure the charging and discharging heat generation characteristics of the battery at a certain fixed temperature point.

The basic principles of isothermal calorimeter are divided into heat flow method and power compensation method. Where the specific working principle of the isothermal calorimeter based on the power compensation method is as follows: a constant temperature boundary is provided for the calorimetric system by an external refrigerant cycle, and the battery to be tested is heated to the target temperature by a heater. After the temperature is stable, the output power of the heater is recorded and used as the baseline power; when the battery starts to work, the temperature of the sensor changes due to the heat absorption or release effect of the battery, and the temperature control system controls the heater power through feedback to keep the sensor temperature at the target temperature, and the power change of the heater is equivalent to the thermal effects of the battery. By integrating the output power of the heater, the heat generation during the battery charging and discharging process may be obtained. It may be known from the working principle that since the heater power controls the battery temperature through real-time feedback, the baseline power of the isothermal calorimeter is easily interfered by ambient temperature fluctuations, and the baseline power data during the calorimetric process may not be directly obtained, and the data needs to be obtained through linear fitting of the heater output power and time before and after charging and discharging, which results in excessive baseline power noise. The baseline power noise of common power compensation-based battery isothermal calorimeter is greater than 10 megawatt (mW). When the battery capacity is small or the charging and discharging rate is low, the battery heat generation power is small, so that in the measurement of charging and discharging heat generation of such batteries by the isothermal calorimeter, the measurement result error is large due to noise interference, thereby reducing the reference value of experimental data.

The lithium battery charging and discharging heat generation measurement method based on the differential isothermal calorimetry calculates the real-time heat flow during battery operation by measuring the temperature difference between the battery to be tested and the reference battery in the dual chambers. Although it may improve the above problems to a certain extent, it needs to obtain the system equivalent heat capacity C and equivalent thermal resistance R, and the experimental steps are relatively complicated.

In addition, there is inevitably a certain thermal hysteresis effect in the measurement of heat generation power. On the one hand, the heat generation of lithium batteries mainly comes from the winding core, and there is an obvious thermal resistance in the heat transfer path from the winding core to the battery surface, and the heat capacity of the battery itself is relatively large; on the other hand, to reduce the contact thermal resistance between the battery and the constant temperature heat sink and improve temperature uniformity, multiple layers of thermal conductive media, including graphite gaskets, silica gel pads and heat uniforming blocks, need to be installed on both sides of the battery before the test. The thermal resistance between various components may not be ignored, so it may be considered that the measurement of battery heat generation power involves an unsteady heat transfer process with a delay link, and the time lag phenomenon in this process leads to the fact that the measurement result may not be directly equivalent to the transient heat generation power of the battery.

Curve fitting, as an important way to deal with errors and correct curves, is widely used in the dynamic characteristic correction of battery isothermal calorimeters. With the increasing complexity of data processing, polynomial fitting has unique advantages in the field of data fitting due to its convenient calculation method and small error. At present, ordinary polynomial fitting uses a polynomial expansion to fit all observation points in a small analysis area containing several analysis grid points. Among them, the linear least square method is a common method to solve the curve fitting problem. By using a set of simple and appropriate linearly independent basis functions to approximate the experimental data, the fitting function f(x) with the smallest overall empirical error may be effectively obtained. However, the regional polynomial fitting of this method is unstable. When the number of data points is large, the polynomial order is too low, and resulting in poor fitting accuracy and effect. To improve the fitting accuracy and effect, it is necessary to increase the curve order, but a too high order will bring computational complexity and other disadvantages. Therefore, it is difficult to achieve good fitting accuracy and effect if only one polynomial curve function is used to fit more data points.

### SUMMARY

In view of the shortcomings of large baseline power noise and deficiencies in dynamic characteristics of the battery isothermal calorimeter mentioned in the background art, the present disclosure designs a differential power compensation type battery isothermal calorimeter and proposes a battery isothermal calorimeter dynamic characteristic correction method based on piecewise polynomial fitting. The present disclosure may reduce interference caused by ambient temperature fluctuations, obtain a real-time changing baseline power, add a constraint condition of continuity of piecewise polynomial fitting at interval segmentation points, and realize dynamic characteristic correction of the battery isothermal calorimeter, thereby improving the accuracy of lithium battery charging and discharging heat generation measurement, with simpler operation; an oil bath device may not be needed when the temperature is above room temperature, which may reduce costs.

The present disclosure provides a differential power compensation type battery isothermal calorimeter, including:
a sample-side device for installing a battery to be tested, where the sample-side device includes a sample-side heat sink, a sample-side heat uniforming block, a sample-ide flexible heating sheet, a sample-side thermal conductive silica gel pad and a sample-side temperature sensor; the sample-side flexible heating sheet, the sample-side heat uniforming block and the sample-side thermal conductive silica gel pad are sequentially stacked on the sample-side heat sink, the battery to be tested is installed between the sample-side flexible heating sheets, and the sample-side temperature sensor is installed in a groove of the sample-side heat uniforming block close to the battery side;
a reference-side device for installing a reference battery, where the reference-side device includes a heat sink, a reference-side heat uniforming block, a reference-side flexible heating sheet, a reference-side thermal conductive silica gel pad and a reference-side temperature sensor; the reference-side flexible heating sheet, the reference-side heat uniforming block and the reference-side thermal conductive silica gel pad are sequentially stacked on the reference-side heat sink, the reference battery is installed between the reference-side flexible heating sheets, and the reference-side temperature sensor is installed in a groove of the reference-side heat uniforming block close to the battery side;
a calorimetric chamber for accommodating the sample-side device and the reference-side device;
a temperature control system for controlling the temperature in the calorimetric chamber to keep the temperatures of the sample-side heat uniforming block and the reference-side heat uniforming block at the target temperature; and
a data acquisition and processing system for acquiring output power data of the sample-side flexible heating sheet and the reference-side flexible heating sheet, and calculating the real-time heat generation power and heat generation of the battery to be tested according to the data.

The present disclosure also provides a dynamic characteristic correction method for a differential power compensation type battery isothermal calorimeter, including the following steps:
step 1, determining the model of a battery to be tested, and selecting a reference battery of the same model and size as the battery to be tested;
step 2, according to the size of the battery to be tested, selecting appropriate flexible heating sheets, heat uniforming blocks and thermal conductive silica gel pads, and installing the sample side and the reference side in the heat sink of the isothermal calorimetric chamber respectively, where the sample side sequentially includes, from top to bottom, a thermal conductive silica gel pad, a heat uniforming block, a flexible heating sheet, the battery to be tested, a flexible heating sheet, a heat uniforming block and a thermal conductive silica gel pad, and the reference side sequentially includes, from top to bottom, a thermal conductive silica gel pad, a heat uniforming block, a flexible heating sheet, the reference battery, a flexible heating sheet, a heat uniforming block and a thermal conductive silica gel pad;
step 3, installing temperature sensors in grooves of the sample-side and reference-side heat uniforming blocks close to the battery side, connecting the sample-side flexible heating sheets in parallel to an external constant current and constant voltage source device, and sealing the isothermal calorimetric chamber after installation;
step 4, determining charging and discharging parameters and a target temperature of the battery to be tested;
step 5, starting the calorimeter, controlling the temperature of the heat sink to a constant temperature point lower than the target temperature, and after the temperature of the calorimetric chamber is stable, controlling the temperatures of the sample-side and reference-side heat uniforming blocks to the target temperature to keep the output power of the flexible heating sheets and the temperature of the heat uniforming blocks stable;
step 6, performing charging and discharging operations on the battery to be tested, controlling the temperature of the sample-side heat uniforming block to be stable at the target temperature, using the temperature of the reference-side heat uniforming block as the reference temperature, maintaining the temperature of the sample-side heat uniforming block consistent with that of the reference side through temperature sensor feedback control, and recording power changes of the sample-side and reference-side flexible heating sheets during charging and discharging;
step 7, calculating a power change rate using the battery heat generation power, adding a constraint condition of continuity at specified points, and fitting the power change rate through piecewise polynomial fitting to obtain the fitted heat generation power and power change rate;
step 8, obtaining a time constant using charging and discharging data, substituting the measured battery heat generation power, time constant and power change rate into a calibration formula to obtain the corrected battery heat generation power, and completing dynamic characteristic correction;
step 9, using the power of the reference-side heating sheet as the baseline power, calculating the difference between the powers of the sample-side and reference-side heating sheets to obtain the real-time heat generation power of the battery to be tested during charging and discharging; and
step 10, integrating the real-time heat generation power of the battery to be tested over time to obtain the heat generation of the battery during charging and discharging.

In conclusion, in order to reduce the impact of ambient temperature fluctuations on the baseline power, the present disclosure designs a differential power compensation type battery isothermal calorimeter to make the baseline power more in line with reality, and proposes a battery isothermal calorimeter dynamic characteristic correction method based on piecewise polynomial fitting, which improves the accuracy of battery charging and discharging heat generation measurement, with simpler operation and lower cost, providing technical support for accurate measurement of lithium-ion battery thermal characteristics.

### BRIEF DESCRIPTION OF THE DRAWINGS

FIG. 1A and FIG. 1B are flow chart of the dynamic characteristic correction method for a differential power compensation type battery isothermal calorimeter.

FIG. 2 is a schematic diagram of the installation of core calorimetric components of the present disclosure.

FIG. 3 is an equivalent heat transfer model of the sample side and reference side.

FIG. 4 is a graph of the power change rate over time before and after fitting in a 53 (Ampere-hour) Ah ternary lithium battery charging experiment.

FIG. 5 is a graph of the power change rate over time before and after fitting in a 53 Ah ternary lithium battery discharging experiment.

FIG. 6 is a graph of the heat generation power over time before and after fitting in a 53 Ah ternary lithium battery charging experiment.

FIG. 7 is a graph of the heat generation power over time before and after fitting in a 53 Ah ternary lithium battery discharging experiment.

FIG. 8 is a power curve of a traditional power compensation type calorimeter and a constant current source in a calibration experiment.

FIG. 9 is a power curve of the present disclosure and a constant current source in a calibration experiment.

In the figures: 1. reference-side battery; 2. sample-side battery; 3. flexible heating sheet; 4. temperature sensor; 5. heat uniforming block; 6. thermal conductive silica gel pad; 7. heat sink; 8. charging and discharging wire; 9. oil bath pipeline; 10. calorimetric chamber; 11. high airtightness aviation plug; 12. gas flowmeter; 13. intake valve; 14. exhaust valve; 15. pressure relief valve.

### DETAILED DESCRIPTION OF THE EMBODIMENTS

To make the steps, technical schemes and advantages of the examples of the embodiments of the present disclosure clearer, the technical schemes in the embodiments of the present disclosure will be described more clearly, in detail and completely below in conjunction with the accompanying drawings in the examples of the embodiments of the present disclosure. The following examples are used to illustrate the present disclosure, but are not intended to limit the scope of the present disclosure.

The present disclosure aims to solve the problems of excessive noise in the baseline power of isothermal calorimeter based on the power compensation method due to susceptibility to ambient temperature fluctuations and the problem of power curve fitting accuracy. Accordingly, the present disclosure designs a differential power compensation type battery isothermal calorimeter and a dynamic characteristic correction method.

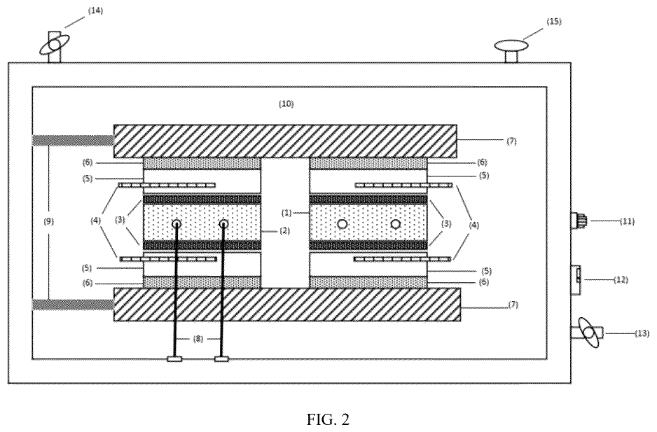

As shown in FIG. 2, the structure of a differential power compensation type battery isothermal calorimeter of the present application is as follows:
selecting corresponding flexible heating sheets 3, heat uniforming blocks 5 and thermal conductive silica gel pads 6 according to the geometric dimensions of the selected sample-side battery 2 and reference-side battery 1 of the same model and size. The side where the battery to be tested is installed is the sample side, and the side where the reference battery is installed is the reference side. The sample side is installed in the heat sink 7 of the isothermal calorimetric chamber 10 in the structure of thermal conductive silica gel pad—heat uniforming block—flexible heating sheet—sample-side battery—flexible heating sheet—heat uniforming block—thermal conductive silica gel pad from top to bottom; the reference side is installed in the heat sink of the isothermal calorimetric chamber in the structure of thermal conductive silica gel pad—heat uniforming block—flexible heating sheet—reference-side battery—flexible heating sheet—heat uniforming block—thermal conductive silica gel pad from top to bottom. The calorimetric chamber 10 is also equipped with a gas flowmeter 12, an intake valve 13, an exhaust valve 14 and a pressure relief valve 15.

In an embodiment, because of installing thermal conductive silica gel pads, heat uniforming blocks and graphite pads, the isothermal calorimeter may reduce the contact thermal resistance between the battery and the constant temperature heat sink and improve temperature uniformity.

In an embodiment, based on the least square method, in the process of solving polynomials of different segments, a constraint condition at specified points is added, and through solving with the condition, the polynomial fitting curves of different segments are made continuous at specified positions.

In an embodiment, by changing the input constraint conditions, the continuity at any position of the curve may be restricted, which may be used not only for piecewise fitting at endpoints, but also for fitting at specified cross data points with cross power data.

In an embodiment, the installation structures of the sample side and the reference side are symmetrical.

In an embodiment, in order to reduce measurement errors, the installation structure of the sample side should be symmetrical to that of the reference side. Selecting charging and discharging wires 8 of appropriate wire diameter according to the model of the battery to be tested and the charging and discharging parameters, connecting the positive and negative electrodes of the battery to be tested to external equipment through wires and high airtightness aviation plugs 11. Installing temperature sensors 4 in the grooves of the upper and lower heat uniforming blocks close to the battery side, and ensuring good fitting with the grooves. Connecting the heat sink with refrigerant to an external oil bath through an oil bath pipeline 9, and closing the calorimetric chamber after installation.

In an embodiment, connecting the battery charging and discharging wires in a four-wire manner may reduce the impact of line impedance on the accuracy of experimental data. using four-wire manner to connect the battery charging and discharging wires, the isothermal calorimeter may reduce the influence of line impedance on the accuracy of experimental data.

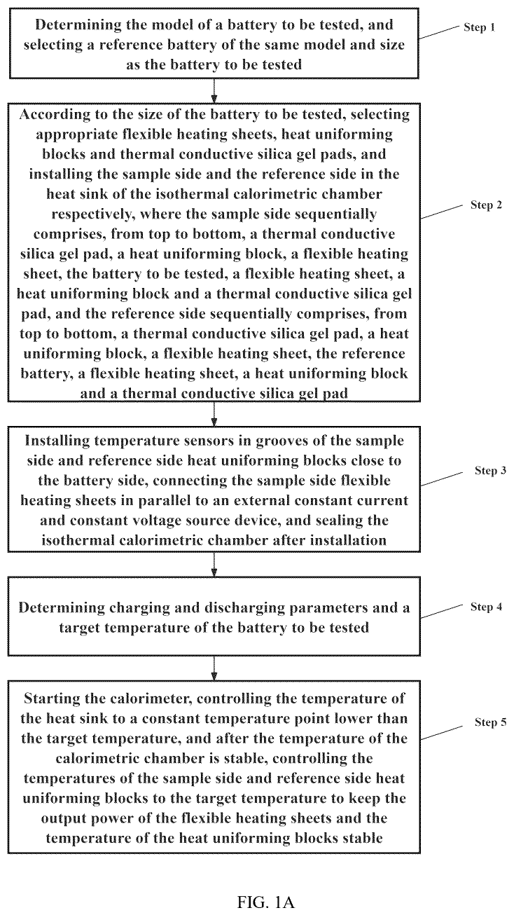

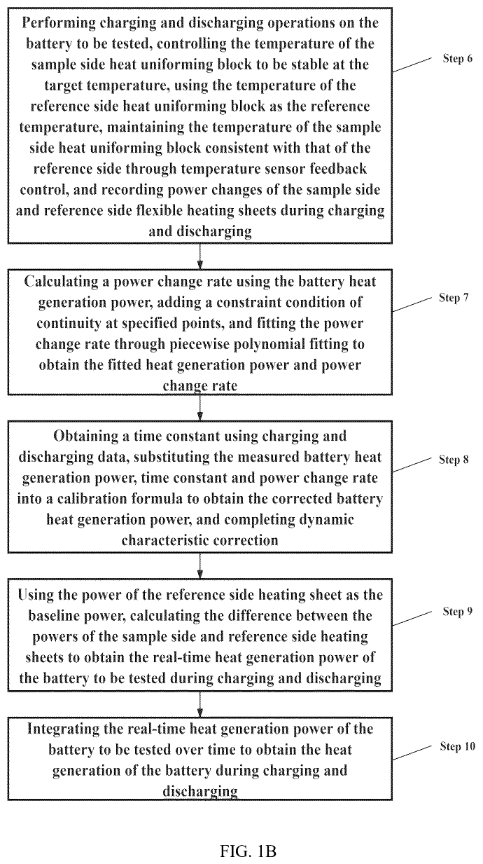

Based on the above device, the dynamic characteristic correction method for the differential power compensation type battery isothermal calorimeter is given below (as shown in FIG. 1A and FIG. 1B):
step 1, determining a model of a battery to be tested, and selecting a reference battery with a same model and a same size as the battery to be tested;
step 2, according to the size of the battery to be tested, selecting appropriate flexible heating sheets, heat uniforming blocks and thermal conductive silica gel pads, and installing a sample side and a reference side in a heat sink of an isothermal calorimetric chamber respectively; wherein the sample side sequentially comprises, from top to bottom, the thermal conductive silica gel pad, the heat uniforming block, the flexible heating sheet, the battery to be tested, the flexible heating sheet, the heat uniforming block and the thermal conductive silica gel pad, and the reference side sequentially comprises, from top to bottom, the thermal conductive silica gel pad, the heat uniforming block, the flexible heating sheet, the reference battery, the flexible heating sheet, the heat uniforming block and the thermal conductive silica gel pad;
step 3, installing temperature sensors in grooves close to the battery side of sample-side and reference-side heat uniforming blocks close to the battery side, connecting a sample-side flexible heating sheet in parallel to an external constant current and constant voltage source device, and sealing the isothermal calorimetric chamber after an installation;
step 4, determining charging and discharging parameters and a target temperature of the battery to be tested;
step 5, starting the calorimeter, controlling a temperature of the heat sink to a constant temperature point lower than the target temperature, and after a temperature of the calorimetric chamber is stable, controlling temperatures of sample-side and reference-side heat uniforming blocks to the target temperature to keep an output power of the flexible heating sheets and the temperature of the heat uniforming blocks stable;
step 6, performing charging and discharging operations on the battery to be tested, controlling the temperature of a sample-side heat uniforming block to be stable at the target temperature, using the temperature of a reference-side heat uniforming block as a reference temperature, maintaining the temperature of the sample-side heat uniforming block consistent with the temperature of the reference side through temperature sensor feedback control, and recording power changes of sample side and a reference-side flexible heating sheet during charging and discharging;
step 7, calculating a power change rate using a battery heat generation power, adding a constraint condition of continuity at specified points, and fitting the power change rate through a piecewise polynomial fitting to obtain a fitted heat generation power and a fitted power change rate;
step 8, obtaining a time constant using charging and discharging data, substituting a measured battery heat generation power, a measured time constant and a measured power change rate into a calibration formula to obtain a corrected battery heat generation power, and completing dynamic characteristic correction;
step 9, using a power of a reference-side heating sheet as a baseline power, calculating a difference between powers of sample-side heating sheet and the reference-side heating sheet to obtain a real-time heat generation power of the battery to be tested during charging and discharging; and
step 10, integrating the real-time heat generation power of the battery to be tested with respect to time to obtain a heat generation of the battery during charging and discharging.

During the experiment, using upper computer software to collect and record the real-time output powers of the sample-side and reference-side heating sheets of the battery isothermal calorimeter. After the battery charging and discharging is completed, analyzing the charging and discharging parameters, extracting the heat generation power, heat generation power change rate, time constant, etc. from the experimental data, and then performing piecewise polynomial fitting on the heat generation power change rate by adding a constraint condition of continuity at specified points, thereby completing the correction of the dynamic characteristics of the battery isothermal calorimeter.

Calculating the heat generation power and heat generation of the sample-side battery during charging and discharging: the real-time heat generation power of the sample-side battery during charging and discharging is obtained according to formula (1), and the heat generation of the battery to be tested is obtained by formula (2).

$${q}_{b} = {q}_{r} - {q}_{s} \qquad ( 1 )$$

$$Q = {\int }_{{t}_{1}}^{{t}_{2}} {q}_{b} dt \qquad ( 2 )$$

Where q_{b} is the real-time heat generation power of the sample-side battery during charging and discharging; qᵣ is the real-time output power of the reference-side heating sheet; qₛ is the real-time output power of the sample-side heating sheet; Q is the heat generation of the sample-side battery in the time period from t₁ to t₂; t₁ is the start time point of charging and discharging of the sample-side battery; t₂ is the time point when the system stabilizes after the end of charging and discharging of the sample-side battery.

The principle of piecewise polynomial fitting will be described in detail below. The idea of the piecewise polynomial fitting method is as follows:
for battery charging and discharging data points (t₁, t₂, t₃ . . . tₙ) and their corresponding heat generation power values (P₁, P₂, P₃ . . . Pₙ), with the polynomial fitting order being m, an n×m matrix may be established according to the least square method. To keep the fitted curve continuous at specified points with the previous segment of the fitting curve, it is necessary to add constraint conditions at specified points to the curve to be fitted. The specific constraint conditions include the data coordinates of the specified points and the derivatives at those points. Ensuring that the data points and the derivatives at the piecewise points are consistent, it may be considered that the two segments of the fitting curve are continuous. The addition of constraint conditions ensures the continuity of the fitting function at interval segmentation points.

In an embodiment, aiming at a section of battery charging and discharging data (t₁, t₂, t₃ . . . tₙ) with n points, whose corresponding power values during battery charging and discharging are (P₁, P₂, P₃ . . . Pₙ), the following two formulas may be established:

$$P = {a}_{0} + {a}_{1} t + {a}_{2} {t}^{2} + ⋯ {a}_{n} {t}^{n} \qquad ( 3 )$$

$${P}^{′} = {a}_{1} + 2 {a}_{2} t + ⋯ {na}_{n} {t}^{n - 1} \qquad ( 4 )$$

Where a₀ to aₙ are the polynomial coefficients to be fitted, formula 3 is the fitted polynomial function, formula (4) is the derivative of formula (3), and P′, namely,

$$( {P}_{1}^{′} , {P}_{2}^{′} … {P}_{n}^{′}$$

is the derivative value corresponding to the battery charging and discharging power value, i.e., the power change rate.

The calculation method of the power change rate may be simplified as the rate of change of data values before and after the point to be calculated, and the following formula may be established:

$${P}_{n}^{′} = \frac{{P}_{n + 1} - {P}_{n - 1}}{{t}_{n + 1} - {t}_{n - 1}} \qquad ( 5 )$$

For a desired fitting curve that may pass through a specific constraint point (t0, P0), the following two formulas may be established:

$${P}_{0} = a + {a}_{1} {t}_{0} + {a}_{2} {t}_{0}^{2} + ⋯ {a}_{n} {t}_{0}^{n} \qquad ( 6 )$$

$${P}_{0}^{′} = {a}_{1} + 2 {a}_{2} {t}_{0} + ⋯ {na}_{n} {t}_{0}^{n - 1} \qquad ( 7 )$$

Formula (6) indicates that the fitted curve passes through the point (t₀, P₀), and formula (7) indicates that the derivative of the fitted curve at this point is a set value. By means of formulas (6) and (7) to constrain the curve, the fitting curves of different segments are connected smoothly and continuously at the constrained point.

For Formula (3) and Formula) the subtraction of the two formulas may be obtained:

$$P - {P}_{0} = {a}_{1} ( t - {t}_{0} ) + {a}_{2} ( {t}^{2} - {t}_{0}^{2} ) + ⋯ {a}_{n} ( {t}^{n} - {t}_{0}^{n} ) \qquad ( 8 )$$

In an embodiment, the formula (7)×(t-t0) may obtain:

$${P}^{′} ( t - {t}_{0} ) = {a}_{1} ( t - {t}_{0} ) + 2 {a}_{2} {t}_{0} ( t - {t}_{0} ) + ⋯ {na}_{n} {t}_{0}^{n - 1} ( t - {t}_{0} ) \qquad ( 9 )$$

In an embodiment, the formula (8) and the formula (9) are subtracted to obtain:

$${α}_{2} [ {t}^{2} - {t}_{0}^{2} - 2 {t}_{0} ( t - {t}_{0} ) ] + ⋯ {a}_{n} [ {t}^{n} - {t}_{0}^{n - 1} - {nt}_{0}^{n - 1} ( t - {t}_{0} ) ] = P - {P}_{0} - {P}^{′} ( t - {t}_{0} ) \qquad ( 10 )$$

For formula (10), there are n power values of t₁, t₂, t₃ . . . tₙ, which may form n equations, converted into the form of matrix multiplication:

$$[ \begin{matrix}{t}_{1}^{2} - {t}_{0}^{2} - 2 {t}_{0} ( {t}_{1} - {t}_{0} ) & ⋯ & {t}_{1}^{n} - {t}_{0}^{n - 1} - {nt}_{0}^{n - 1} ( {t}_{1} - {t}_{0} ) \\ ⋮ & ⋱ & ⋮ \\ {t}_{n}^{2} - {t}_{0}^{2} - 2 {t}_{0} ( {t}_{n} - {t}_{0} ) & ⋯ & {t}_{n}^{n} - {t}_{0}^{n - 1} - {nt}_{0}^{n - 1} ( {t}_{n} - {t}_{0} )\end{matrix} ] [ \text{} \begin{matrix}{a}_{2} \\ ⋮ \\ {a}_{n}\end{matrix} ] = [ \begin{matrix}{P}_{1} - {P}_{0} - {P}_{1}^{′} ( {t}_{1} - {t}_{0} ) \\ ⋮ \\ {P}_{n} - {P}_{0} - {P}_{n}^{′} ( {t}_{n} - {t}_{0} )\end{matrix} ] \qquad ( 11 )$$

By solving the above matrix, the values of a₂ to aₙ may be obtained.

Substituting the values of a₂ to aₙ into formula (7) may solve for the value of a₁, and then substituting the values of a₁ to aₙ into formula (6) may solve for a₀. So far, the polynomial coefficients a₀ to aₙ are completely obtained. Substituting the coefficients into formula (3) may obtain the fitted value.

In one embodiment, the above method is implemented in Matlab software, constructing the function function [P_out, poly_P]=polyxfit(t, P, n, t₀, P₀, dP₀), where t and P are the time and power values of the battery charging and discharging to be fitted, t₀ and P₀ are the values of the constrained fitting curve at this point, dP₀ is the derivative of the constrained fitting curve at this point, n is the order of the fitted polynomial, and P_out, poly_P are the P value of the fitted curve and its derivative value respectively.

The first-order calibration formula after simplification of the unsteady heat transfer equation of the battery isothermal calorimetry core system is:

$${P}_{corrected} = {P}_{measured} + τ \cdot \frac{dP}{dt} \qquad ( 12 )$$

Where P_{corrected} is the corrected battery heat generation power, P_{measured} is the battery heat generation power measured by the instrument, r is the time constant, and is the power change rate, τ is related to the battery heat capacity and the thermal resistance between the battery and the heating sheet.

Using the above method to correct the dynamic characteristics of the battery isothermal calorimeter, the parameters of the battery to be tested are shown in Table 1

TABLE 1
Parameters of the battery charging and discharging experiment

| | Charging experiment | Discharging experiment |
|---|---|---|
| Battery | 53 (Ampere-hour) Ah nickel-cobalt-manganese ternary lithium battery | |
| specification | | |
| Charging and | Constant current-constant voltage | Constant current discharging, |
| discharging | charging, charging voltage 4.2 Voltage | discharging current 0.5 C, |
| conditions | (V), charging current 0.5 Coulomb (C), | discharging cut-off voltage |
| | charging cut-off current 0.05 C. | 2.5 V. |
| Heat sink | 22 | 22 |
| temperature | | |
| Isothermal target | 25 | 25 |
| temperature | | |

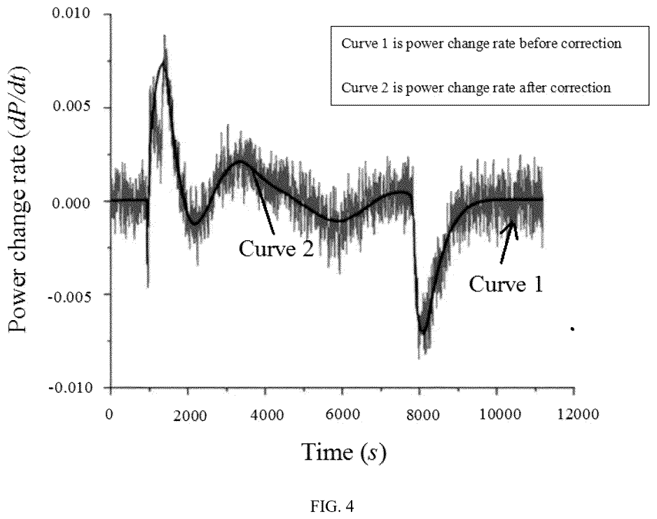

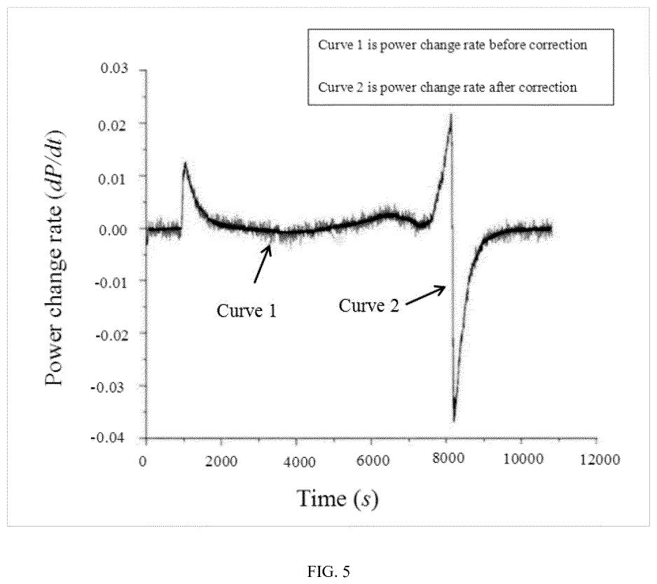

FIG. 4 is a graph of the battery eat generation power change rate over time during charging of the battery isothermal calorimeter, where curve 1 is the curve before correction and curve 2 is the curve after correction. FIG. 5 is a graph of the battery heat generation power change rate over time during discharging of the battery isothermal calorimeter, where curve 1 is the curve before correction and curve 2 is the curve after correction. It may be seen from the measured curves in FIG. 4 and FIG. 5 that the power change rate obtained by direct calculation has large noise, so fitting is required. The data is divided into 16 segments during the battery charging process and 15 segments during the battery discharging process. Each segment of data has cross sample points with the front and rear output. By adjusting the order and limiting the continuous points, and removing redundant cross sample curves, the corrected continuous piecewise fitting curve is obtained, namely, the curve after correction in FIG. 4 and FIG. 5.

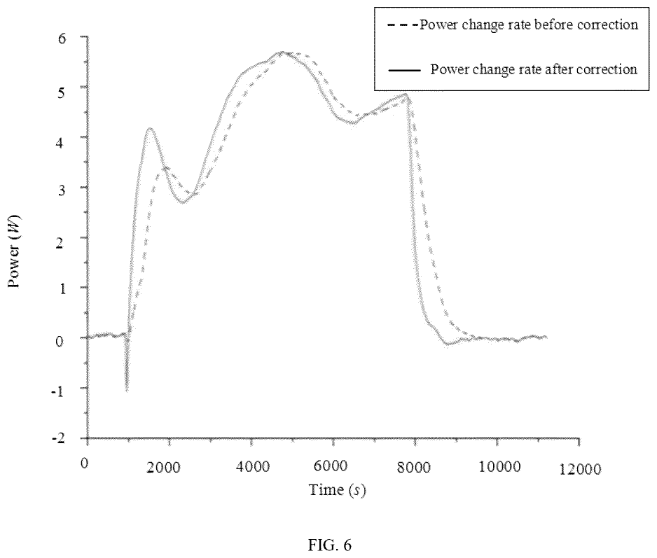

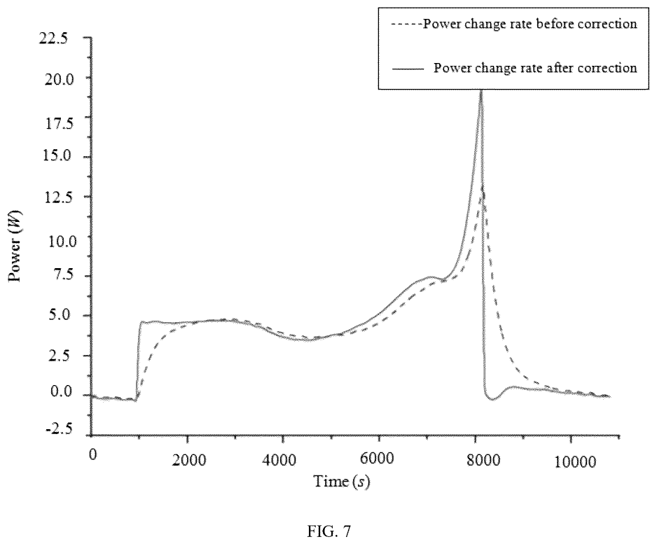

Using the measured discharging heat generation power curve of the battery isothermal calorimeter, the time constant is obtained as 318 seconds (s). The corrected power value at each moment may be obtained according to formula (11). FIG. 6 is a graph of the heat generation power over time during charging of the battery isothermal calorimeter, where dotted line is the curve before correction and full line is the curve after correction; FIG. 7 is a graph of the heat generation power over time during discharging of the battery isothermal calorimeter, where dotted line is the curve before correction and full line is the curve after correction. Table 2 shows the lithium battery charging and discharging heat generation data before and after the dynamic characteristic correction of the isothermal calorimeter.

TABLE 2
Battery charging and discharging heat generation before and after
isothermal calorimeter dynamic characteristic correction

| Battery charging and | Heat generation before | Heat generation after |
|---|---|---|
| discharging experiment | correction (Joule (J) | correction (J) |
| Charging experiment | 30952.939 | 30950.576 |
| Discharging experiment | 40377.047 | 40258.126 |

The correction results show that the battery isothermal calorimeter dynamic characteristic correction method based on piecewise polynomial fitting proposed in the embodiment of the present application greatly improves the thermal hysteresis of the isothermal calorimeter, while ensuring the accuracy of battery charging and discharging heat generation data.

The sample-side and reference-side structures will be analyzed below, and a detailed mathematical model derivation will be performed by constructing their equivalent circuit diagrams.

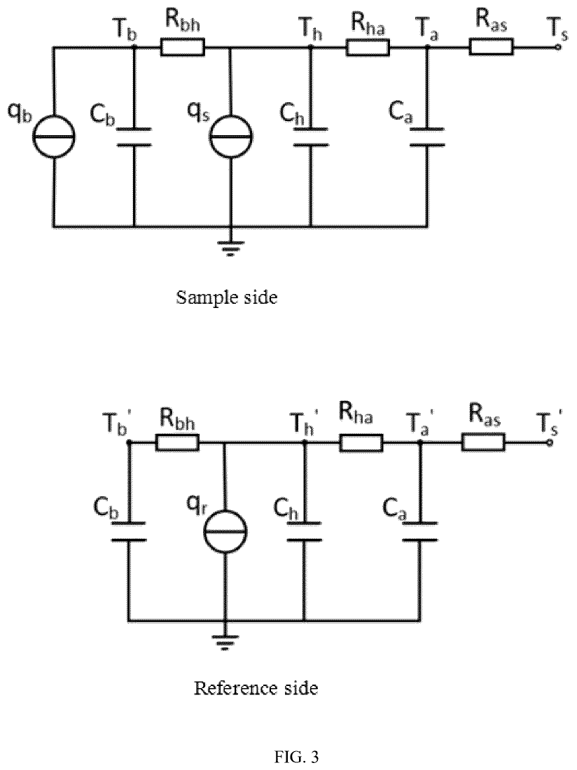

For the isothermal calorimeter structure shown in FIG. 2, the equivalent circuit diagram of the sample-side heat transfer model is shown on the sample side of FIG. 3, where T is temperature, C is heat capacity, R is thermal resistance; subscript b represents battery, h represents heater, a represents heat uniforming block, s represents heat sink; q_{b} is the heat generation power of the battery to be tested; qₛ is the output power of the sample-side heating sheet; R_{bh} is the sum of thermal resistances between the heater and the battery; Rₕₐ is the sum of thermal resistances between the heater and the heat uniforming block; Rₐₛ is the sum of thermal resistances between the heat uniforming block and the heat sink.

For the sample-side battery, its thermal energy change consists of two parts: one is the heat power generated or absorbed during charging and discharging, and the other is the heat conduction power with the heating sheet. The thermal energy change equation of the sample-side battery is shown in formula (13):

$${C}_{b} \frac{{dT}_{b}}{dt} = {q}_{b} + \frac{{T}_{h} - {T}_{b}}{{R}_{hb}} \qquad ( 13 )$$

The first term on the right side of formula (13) represents the heat generation power of the sample-side battery, and the second term represents the heat exchange power between the battery and the heater.

For the heating sheet, its thermal energy change also consists of two parts: one is the Joule heat power converted from electrical energy, and the other is the heat conduction power with the heat uniforming block and the sample-side battery. The thermal energy change equation of the sample-side heating sheet is shown in formula (14):

$${C}_{h} \frac{d {T}_{h}}{dt} = {q}_{s} + \frac{{T}_{a} - {T}_{h}}{{R}_{ah}} + \frac{{T}_{b} - {T}_{h}}{{R}_{b h}} \qquad ( 14 )$$

The first term on the right side of formula (14) represents the heat generation power of the heater, the second term represents the heat exchange power between the heater and the heat uniforming block, and the third term represents the heat exchange power between the heater and the battery.

The sample-side heat uniforming block has no internal heat source, so the thermal energy change equation is shown in formula (15). The two terms on the right side respectively represent the heat conduction power between the heat uniforming block and the heat sink, and between the heat uniforming block and the heater:

$${C}_{a} \frac{d {T}_{a}}{{d}_{t}} = \frac{{T}_{s} - {T}_{a}}{{R}_{sa}} + \frac{{T}_{h} - {T}_{a}}{{R}_{ha}} \qquad ( 15 )$$

Combining formulas (13), (14) and (15), the total thermal energy change equation of the sample side is obtained:

$${C}_{b} \frac{{dT}_{b}}{d t} + {C}_{h} \frac{{dT}_{h}}{dt} + {C}_{a} \frac{d {T}_{a}}{{d}_{t}} = {q}_{b} + {q}_{s} + \frac{{T}_{S} - {T}_{a}}{{R}_{sa}} \qquad ( 16 )$$

Integrating both sides of formula (16) over time, since the temperatures of various components remain unchanged before and after charging and discharging, formula (16) may be transformed into formula (17).

$$0 = \int ( \frac{{T}_{S} - {T}_{a}}{{R}_{sa}} - {q}_{s} - {q}_{b} ) {d}_{t} \qquad ( 17 )$$

It may be known from formula (17) that under ideal conditions, the heat sink temperature Tₛ and the heat uniforming block temperature Ta are considered to be constant, and the heat conduction power between the heat uniforming block and the heat sink is constant, which is the sample-side baseline power. This power is maintained by the battery heat absorption or release power and the heater compensation power qₛ, and is obtained by linear fitting of the heater output power and time before and after charging and discharging. However, in actual situations, the heat uniforming block temperature Ta is easily affected by ambient temperature fluctuations, resulting in large noise in the sample-side baseline power. Therefore, the output power of the reference-side heating sheet is used as the real-time baseline power to reduce environmental impact.

For the isothermal calorimeter structure shown in FIG. 2, the equivalent circuit diagram of the reference-side heat transfer model is shown on the reference side of FIG. 3. The sample-side and reference-side structures are the same, so it may be considered that the heat capacities and thermal resistances of both sides are equal, where the superscript “ ” represents the reference side; T is temperature, C is heat capacity, R is thermal resistance; subscript b represents battery, h represents heater, a represents heat uniforming block, s represents heat sink; qᵣ is the output power of the reference-side heating sheet.

The reference battery is not connected to an external battery charging and discharging tester, so there is no internal heat source, and its heat generation power is 0. The thermal energy change equation of the reference battery is shown in formula (18):

$${C}_{b} \frac{{dT}_{{b}^{′}}}{dt} = 0 + \frac{{T}_{{h}^{′}} - {T}_{{b}^{′}}}{{R}_{hb}} \qquad ( 18 )$$

The thermal energy change equation of the reference-side heating sheet is shown in formula (19):

$${C}_{h} \frac{d {T}_{{h}^{′}}}{dt} = {q}_{r} + \frac{{T}_{{a}^{′}} - {T}_{{h}^{′}}}{{R}_{ah}} + \frac{{T}_{{b}^{′}} - {T}_{{h}^{′}}}{{R}_{b h}} \qquad ( 19 )$$

The thermal energy change equation of the reference side heat uniforming block is shown in formula (20):

$${C}_{a} \frac{d {T}_{{a}^{′}}}{{d}_{t}} = \frac{{T}_{{s}^{′}} - {T}_{{a}^{′}}}{{R}_{sa}} + \frac{{T}_{{h}^{′}} - {T}_{{a}^{′}}}{{R}_{ha}} \qquad ( 20 )$$

Combining formulas (18), (19) and (20), the total thermal energy change equation of the reference side is obtained:

$$0 = \int ( \frac{{T}_{{a}^{′}} - {T}_{{s}^{′}}}{{R}_{sa}} - {q}_{r} ) {d}_{t} \qquad ( 21 )$$

It may be known from formula (21) that the heat conduction power between the reference side heat uniforming block and the heat sink is maintained by the heater output power, and the reference-side heating sheet power may be used as the baseline power.

During the experiment, the sample-side heat sink temperature Tₛ is equal to the reference side heat sink temperature Tₛ, and the temperature control system keeps the sample-side heat uniforming block temperature Ta consistent with the reference side reference temperature Ta. Therefore, it may be known from formulas (17) and (21) that the reference-side baseline power may be used as the sample-side baseline power, that is, formula (22).

$${q}_{r} = {q}_{s} + {q}_{b} \qquad ( 22 )$$

Then, the sample-side battery real-time heat generation power formula (23) may be obtained:

$${q}_{b} = {q}_{r} - {q}_{s} \qquad ( 23 )$$

Integrating the sample-side battery real-time heat generation power over time gives the heat generation of the battery during charging and discharging, as shown in formula (24):

$$Q = {\int }_{{t}_{1}}^{{t}_{2}} {q}_{b} dt \qquad ( 24 )$$

Using the above method to conduct a calibration experiment.

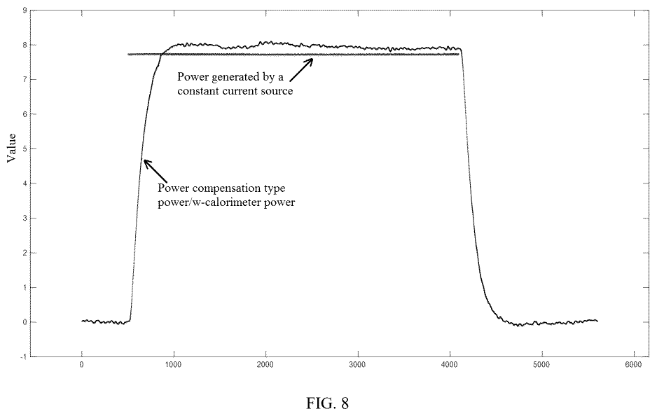

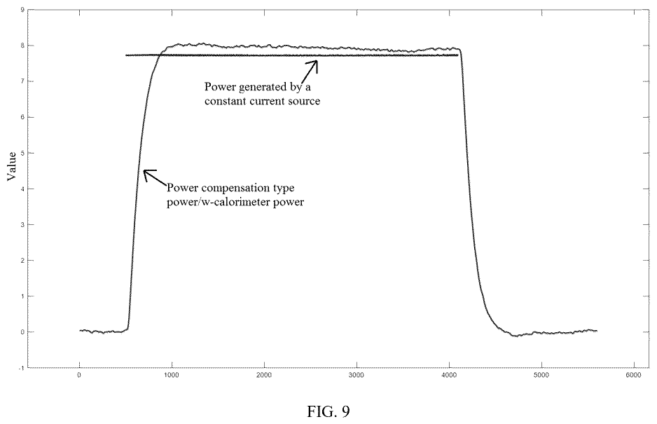

FIG. 8 is a power curve of a traditional power compensation type calorimeter and a constant current source in a calibration experiment. FIG. 9 is a power curve of the present application, that is, a differential power compensation type calorimeter, and a constant current source in a calibration experiment. It may be known from FIG. 8 and FIG. 9 that the present application makes up for the disadvantage that the baseline of the battery isothermal calorimeter is easily affected by ambient temperature fluctuations, resulting in large power noise; at the same time, compared with the heat flow method isothermal calorimeter, the operation is simpler, improving measurement efficiency; and no oil bath device is needed when the temperature is above room temperature. The present disclosure improves the accuracy of battery thermal characteristic measurement while having the advantages of isothermal calorimeters, ensures measurement efficiency, and has lower cost.

What is claimed is:

1. A dynamic characteristic correction method for a differential power compensation type battery isothermal calorimeter, comprising following steps:
step 1, determining a model of a battery to be tested, and selecting a reference battery with a same model and a same size as the battery to be tested;
step 2, according to the size of the battery to be tested, selecting appropriate flexible heating sheets, heat uniforming blocks and thermal conductive silica gel pads, and installing a sample side and a reference side in a heat sink of an isothermal calorimetric chamber respectively; wherein the sample side sequentially comprises, from top to bottom, the thermal conductive silica gel pad, the heat uniforming block, the flexible heating sheet, the battery to be tested, the flexible heating sheet, the heat uniforming block and the thermal conductive silica gel pad, and the reference side sequentially comprises, from top to bottom, the thermal conductive silica gel pad, the heat uniforming block, the flexible heating sheet, the reference battery, the flexible heating sheet, the heat uniforming block and the thermal conductive silica gel pad;
step 3, installing temperature sensors in grooves close to the battery side of sample-side and reference-side heat uniforming blocks close to the battery side, connecting a sample-side flexible heating sheet in parallel to an external constant current and constant voltage source device, and sealing the isothermal calorimetric chamber after an installation;
step 4, determining charging and discharging parameters and a target temperature of the battery to be tested;
step 5, starting the calorimeter, controlling a temperature of the heat sink to a constant temperature point lower than the target temperature, and after a temperature of the calorimetric chamber is stable, controlling temperatures of sample-side and reference-side heat uniforming blocks to the target temperature to keep an output power of the flexible heating sheets and the temperature of the heat uniforming blocks stable;
step 6, performing charging and discharging operations on the battery to be tested, controlling the temperature of a sample-side heat uniforming block to be stable at the target temperature, using the temperature of a reference-side heat uniforming block as a reference temperature, maintaining the temperature of the sample-side heat uniforming block consistent with the temperature of the reference side through temperature sensor feedback control, and recording power changes of sample side and a reference-side flexible heating sheet during charging and discharging;
step 7, calculating a power change rate using a battery heat generation power, adding a constraint condition of continuity at specified points, and fitting the power change rate through a piecewise polynomial fitting to obtain a fitted heat generation power and a fitted power change rate;
step 8, obtaining a time constant using charging and discharging data, substituting a measured battery heat generation power, a measured time constant and a measured power change rate into a calibration formula to obtain a corrected battery heat generation power, and completing dynamic characteristic correction;
step 9, using a power of a reference-side heating sheet as a baseline power, calculating a difference between powers of sample-side heating sheet and the reference-side heating sheet to obtain a real-time heat generation power of the battery to be tested during charging and discharging; and
step 10, integrating the real-time heat generation power of the battery to be tested with respect to time to obtain a heat generation of the battery during charging and discharging.

2. The dynamic characteristic correction method for the differential power compensation type battery isothermal calorimeter according to claim 1, wherein the piecewise polynomial fitting in the step 7 is based on a least square method, and the constraint condition of the continuity at specified points is added during the fitting to ensure smooth transition of a fitted curve at piecewise points.

3. The dynamic characteristic correction method for the differential power compensation type battery isothermal calorimeter according to claim 1, wherein the calibration formula in the step 8 is:
$${P}_{corrected} = {P}_{measured} + τ \cdot \frac{d P}{d t}$$
wherein P_{corrected} is the corrected battery heat generation power, P_{measured} is a battery heat generation power measured by an instrument, r is the time constant, and is the power change rate.

4. The dynamic characteristic correction method for the differential power compensation type battery isothermal calorimeter according to claim 3, wherein a formula for calculating the real-time heat generation power in step 9 is:
$${q}_{b} = {q}_{r} - {q}_{s}$$
wherein q_{b} is the real-time heat generation power of the battery to be tested during charging and discharging; gᵣ is a real-time output power of the reference-side heating sheet; qₛ is a real-time output power of the sample-side heating sheet.

5. The dynamic characteristic correction method for the differential power compensation type battery isothermal calorimeter according to claim 3, wherein a formula for calculating the heat generation in step 10 is:
$$Q = {\int }_{{t}_{1}}^{{t}_{2}} {q}_{b} dt$$
wherein Q is a heat generation of the battery to be tested in a time period from t₁ to t₂; wherein t₁ is a start time point of the charging and discharging of the battery to be tested; t₂ is a time point when a system stabilizes after an end of the charging and discharging of the battery to be tested.
